(19) United States
(12) Patent Application Publication
(10) Pub. No.: US 2002/0191492 A1
(43) Pub. Date: Dec. 19, 2002

(54) Electronic automatic world-wide time/clock synchronization method

(75) Inventors: Robert J. Kamper, Round Rock, TX (US); Larry Don Swofford, Georgetown, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/881,914

(22) Filed: Jun. 14, 2001

(51) Int. Cl. G04C 11/02

(52) U.S. Cl. 368/47

(57) ABSTRACT

A method, system and computer program product for determining time synchronization of a timing device is provided. Geographic position data is obtained from a device associated with the timing device. A current local time is calculated for a location of the device associated with the timing device based on the geographic position data. The timing device is then synchronized with the current local time.

### BACKGROUND OF THE INVENTION

1. Technical Field

The present invention relates generally to an improved data processing system and, more specifically, to providing time management in synchronizing clocks and time pieces to local time. Still more specifically, the present invention is directed to an electronic automatic world-wide time/clock synchronization method for adjusting clocks and time pieces to local time depending on where the clock or time piece is located at a specific point in time.

2. Description of Related Art

Numerous problems are associated with the lack of synchronization of clocks and time pieces used for both work and pleasure. Everyone is familiar with the flashing 12:00 on a video cassette recorder (V(R) as a result of the VCR losing power. However, the problem goes much deeper than this. For example, when a power outage occurs, many electronic devices within the home and business contain a clock, which in the event of the power outage, automatically resets back to the standard 12:00 time and must be reset manually to the correct time. The problems and annoyance of having to provide this manual resetting of all the clocks and time pieces is compounded by the fact that an ever increasing variety of electronic devices contain these clocks. In addition, many people have awakened in the morning to find out that a power interruption has occurred during the night for an extended period of time and the clocks are at least several minutes if not an hour or two, behind the actual time.

As most people know, daylight savings time in the United States takes effect every spring and reverts back to standard time every fall. The hassle and frustration of having to set all clocks and time pieces in the home and at work is at least inconvenient and at most a exercise in futility in trying to locate and reset all clocks and time pieces to the proper time.

Furthermore, when traveling by, for example, automobile, airplane, rail, or bus, once a time zone boundary is crossed, the clock or time piece must again be manually reset to the correct local time. This could become confusing when traveling in the United States and trying to decide, for example, if the central time zone is an hour ahead or an hour behind the mountain time zone. Even a greater amount of confusion is probable if flying internationally and attempting to keep track of the multiple time zones crossed during the trip. For example, it would be desirable to know the local current time regardless of what time zone the traveler is in. Also, it would be desirable to not have to remember to set a clock or time piece forward or backward an hour each time another time zone boundary is reached.

Therefore, it would be advantageous to have an improved method and apparatus for automatically synchronizing electronic clocks and time pieces to the correct local time irrespective of where the clock or time piece is located in the world.

### SUMMARY OF THE INVENTION

The present invention provides a method, system and computer program product for determining time synchronization of a timing device. Geographic position data is obtained from a device associated with the timing device. A current local time is calculated for a location of the device associated with the timing device based on the geographic position data. The timing device is then synchronized with the current local time.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a computing system in accordance with a preferred embodiment of the present invention;

FIG. 2 is a pictorial representation of a networked data processing system in which the present invention may be implemented;

FIG. 3 is a block diagram of a data processing system, which may be implemented as a server, in accordance with a preferred embodiment of the present invention;

FIG. 4 is an exemplary diagram of a time device according to a preferred embodiment of the present invention;

FIG. 5 is an exemplary illustration of adjusting the time for a device crossing time zone boundaries in accordance with a preferred embodiment of the present invention;

FIG. 6 is an exemplary illustration of adjusting the time for a device after an interruption in power to the device in accordance with a preferred embodiment of the present invention; and

FIG. 7 is an exemplary flow chart illustrating adjusting time on a clock or time piece in accordance with a preferred embodiment of the present invention.

### DETAILED DESCRIPTION OF THE PREFERRED EMBODIMENT

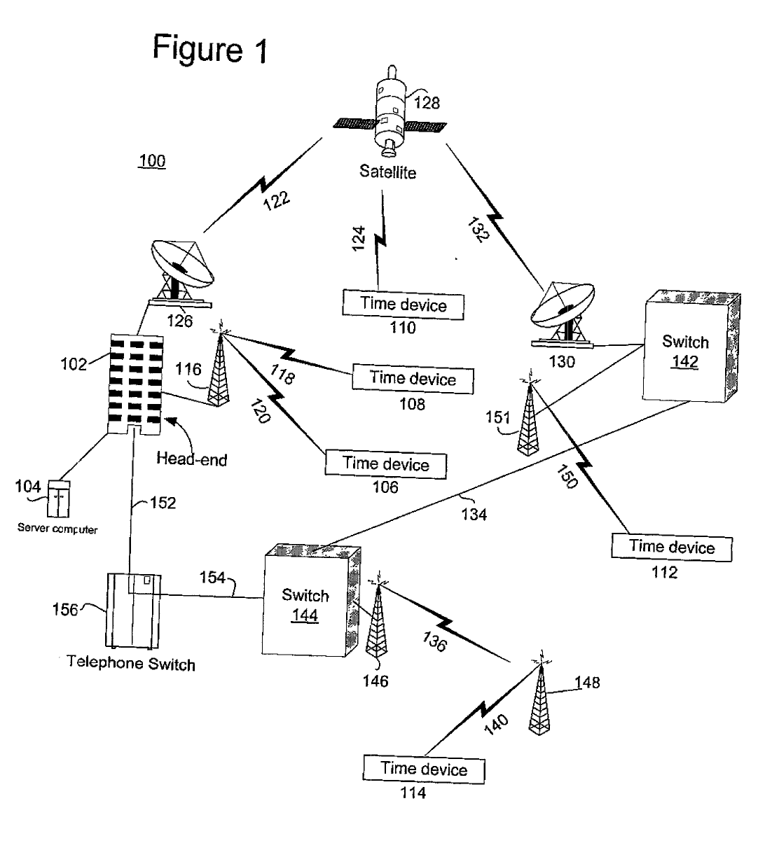

With reference now to the figures and in particular with reference to FIG. 1, a diagram of a computing system 100 is depicted in accordance with a preferred embodiment of the present invention. In this example, head-end 102 is connected to a server computer 104, which is employed to collect data from various computing platforms that may be present within computing system 100. In particular, server computer 104 may communicate with various time devices 106-114, which may be, for example, a clock or a time piece. These mobile units each contain a computing platform, which may communicate with server 104. In this example, communications between various time devices may be accomplished through a cellular phone system or through an Iridium satellite phone system or other wireless systems.

Communications between server computer 104 and time devices 106-114 is accomplished in a number of different ways in this example. For example, radio tower 116 provides communications links 118 and 120 to time devices 108 and 106 respectively. Communications links 118 and 120 are radio frequency communications links generated between radio tower 116 and antennas located at time devices 106 and 108. In addition, server 104 may communicate with time device 110 through communications links 122 and 124. Communications link 122 is established between satellite dish 126 and satellite switch 128 with communications link 124 being established between satellite 128 and time device 110. Communications links 122 and 124 are radio frequency based links generated by signals sent to satellite switch 128 from satellite dish 126 and from satellite switch 128 to time device 110. In these examples, radio tower 116 and satellite dish 126 are connected to head-end 102 and provide for transmissions originating from or passing through head-end 102.

Further, signals may be sent from satellite switch 128 to satellite dish 130 via communications link 132. From satellite dish 130, information may be sent to time device 114 through communications link 134, 136, and 140. Communications link 134 in this example is a link between switch 142 and switch 144. In this manner, a path may be established from server computer 104 to time device 114 to create a path containing communications links 122, 132, 134, 136, and 140. Communications link 134 is a physical link, which may be for example, coaxial cable, fiber optic cable, or a combination of the two. Each switch also has a “link”, also called a “path” within the switch for writing data through the switch. An “input link” is the input or source portion of the link associated with the input into the switch, and an “output link” is the output or destination portion of the link associated with the output from the switch. Communications link 136 is established between radio towers 146 and 148. Radio tower 146 is connected to switch 144 in FIG. 1. Communications link 140 is established between radio tower 148 and time device 114. Communications with time device 112 may be established through a path containing communications links 122, 132, and 150. Communications link 150 is established between radio tower 151 and time device 112. In this example, satellite dish 130 and radio tower 151 are connected to switch 142.

In addition, server computer 104 may use an alternate path to communicate with time device 114. For example, a path through communications links 152, 154, 136, and 140 may be employed to communicate with time device 114. Links 152 and 154 are physical links in this example. Communications link 152 is established between head-end 102 and switch 156, while communications link 154 is established between switch 156 and switch 144. In this manner, data signals, such as multi-media data, which may include video, graphics, voice, and text may be sent between server computer 104 and time devices 106-114.

Time devices 106-114 in FIG. 1 may contain a browser for locating sites on the Internet, an audio unit for announcing data either received by or contained in time devices 106-114 and, for example, a GPS unit for locating the position of time devices 106-114. Time devices 106-114 may also contain an application which may be, for example, Internet communications software, for enabling communications between, for example, the Internet and a mobile unit. The browser may receive position data of the mobile unit along with device characteristic data of a clock or time piece for which local current time of the clock or time piece is to be determined based on the location. A time piece may be a time device which is part of an appliance, such as, for example, a timing device incorporated in a video cassette recorder, microwave, a radio, and the like. A clock may be, for example, a wrist watch, stop watch, and the like. The device characteristic data of the clock or time piece may be, for example, input via the mobile unit, stored within the mobile unit, or stored on a server. A server, such as server 104, may contain an application, such as local current time computation software to compute local current time information for the clock or time piece based on position data and device characteristics. The local current time information may then be sent to a web server which then transmits the computed local current time information via the Internet communications software which then transmits the computed local current time information to a mobile unit, such as, for example, one or more time devices 106-114.

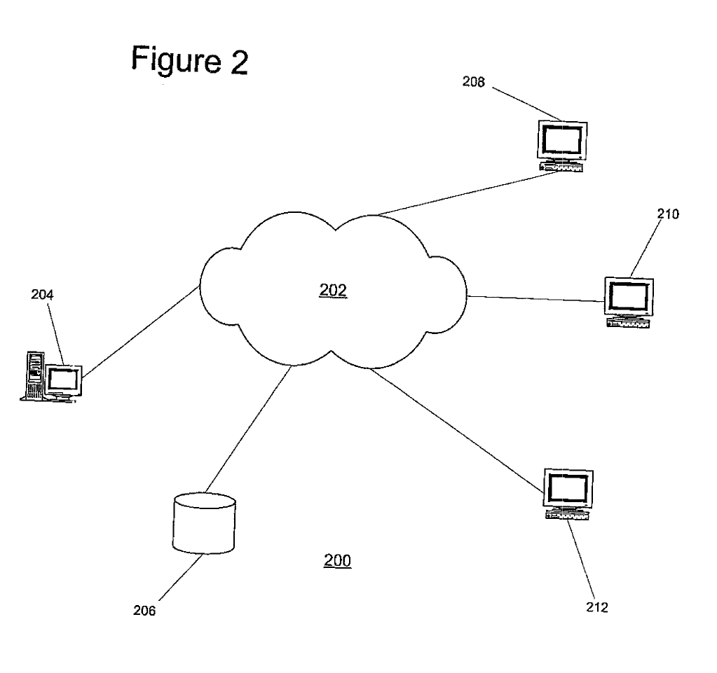

FIG. 2 is a pictorial representation of a networked data processing system in which the present invention may be implemented. Networked data processing system 200 is a network of computers in which the present invention may be implemented. Networked data processing system 200 contains a network 202, which is the medium used to provide communications links between various devices and computers connected together within networked data processing system 200. Network 202 may include wireline connections, such as copper wire or fiber optic cables, and wireless connections, such as cellular telephone connections. Also, the connections for network 202 may be either permanent, such as with a dedicated line, and/or temporary, such as connections made through dial up telephone connections.

In the depicted example, a server 204, such as, for example, server 104 in FIG. 1 is connected to network 202 along with storage unit 206. In addition, clients 208, 210, and 212 also are connected to network 202. These clients 208, 210, and 212 may be, for example, personal computers, mobile devices such as cellular phones, internet enabled personal digital assistants (PDAs) or network computers. For purposes of this application, a network computer is any computer, coupled to a network, which receives a program or other application from another computer coupled to the network. In the depicted example, server 204 provides data and applications to clients 208, 210, and 212. Clients 208, 210, and 212 are clients to server 204. In a multi-tier networked environment, networked applications are provided in which a portion of the application is located on a server, such as server 204 and another portion of the application is located on a client, such as client 208. In this implementation, the client is considered a first tier system while the server is considered a second tier system.

Networked data processing system 200 may include additional servers, clients, and other devices not shown. In the depicted example, networked data processing system 200 is the Internet with network 202 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems, that route data and messages. Of course, networked data processing system 200 also may be implemented as an number of different types of networks, such as, for example, an intranet or a local area network. Popular communication protocols may be hypertext transfer protocol or wireless applications housed in the network.

FIG. 2 is intended as an example, and not as an architectural limitation for the processes of the present invention. For example, network 202 may use other hardware devices, such as, plotters, optical scanners, and the like in addition or in place of the hardware depicted in FIG. 2.

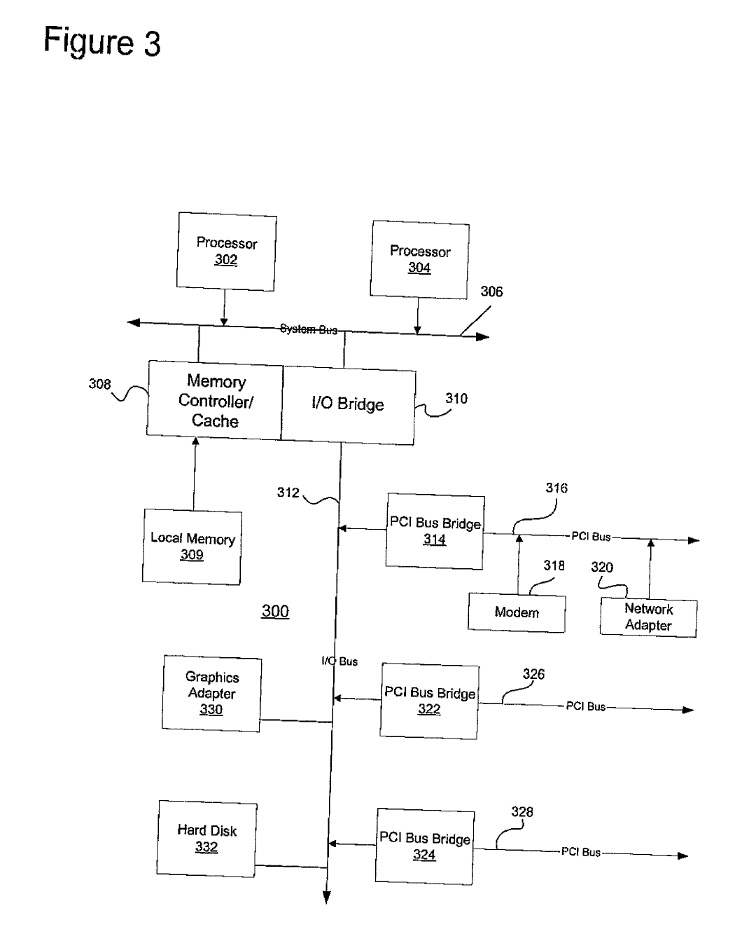

FIG. 3 is a block diagram depicts a data processing system in accordance with a preferred embodiment of the present invention. FIG. 3 may be implemented as a server, such as server computer 104 in FIG. 1. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems 318-320 may be connected to PCI bus 316. Typical PCI bus implementations will support four PCI expansion slots or add-in connectors. Communications links to transmitters in FIG. 1 may be provided through modem 318 and network adapter 220 connected to PCI local bus 316 through add-in boards.

Additional PCI bus bridges 322 and 324 provide interfaces for additional PCI buses 326 and 328, from which additional modems or network adapters may be supported. In this manner, server 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as an optical disk drive and the like, also may be used in addition to or in place of the hardware depicted. The depicted example is not meant to imply architectural limitations with respect to the present invention.

The data processing system depicted in FIG. 3 may be, for example, an IBM eServer pSeries, a product of International Business Machines Corporation in Armonk, N.Y., running the Advanced Interactive Executive (AIX) operating system or the Linux operating systems.

The present invention provides a method and apparatus to be included in any electronic device requiring clock or time synchronization. The method and apparatus may have the ability to detect and receive a signal, such as, for example, a global positioning signal (GPS), from, for example, a satellite in global orbit around the Earth. The method and apparatus may use, for example, triangulation/delay, which senses the location of the device in the world, the local current time associated with the location of the device and then automatically validates or sets the clock or time piece based on the location and local current time information.

Since a satellite in global orbit around the Earth provides a more accurate method of determining and establishing a current local time for any position on the globe, a signal from the satellite is able to provide accurate time to any device containing, for example, a mini-receiver. The mini-receiver associated with the time device may be located anywhere on the globe, flying above the globe or even located in outer space beyond the globe. The device containing the apparatus of the present invention may no longer require human intervention to validate and/or update a clock or time piece associated with the device.

As an example of the utility of the present invention, a person traveling from New York, N.Y. to San Francisco, Calif. with an extended layover in Dallas, Tex. may be required to reset their clock or time piece multiple times during the trip as they move from the Eastern time zone, laying over in the Central time zone and finally arriving in the Pacific time zone. If the person's clock or time piece were so equipped with the apparatus of the present invention, their clock or time piece may be provided with a periodic validation and/or update on the local time in which the device is presently located. The periodic validation and/or update may be as short as a fraction of a second or be as long as a few hours or even a day between validation and/or updates.

If the person's clock or time piece were so equipped with the apparatus of the present invention, a signal would be received and the clock or time piece associated with the device would be updated and/or validated regularly. These regular updates and/or validations would assure that the person's clock or time piece would have the correct local time based on the location of the device associated with the clock or time piece. The time may be automatically adjusted when, for example, the time device crosses a time zone boundary or an adjustment is made for daylight savings time or standard time. Further, the correct current local time is automatically inputted into the time device to reflect the correct current local time after restoration of power after an interruption in the power signal to the time device.

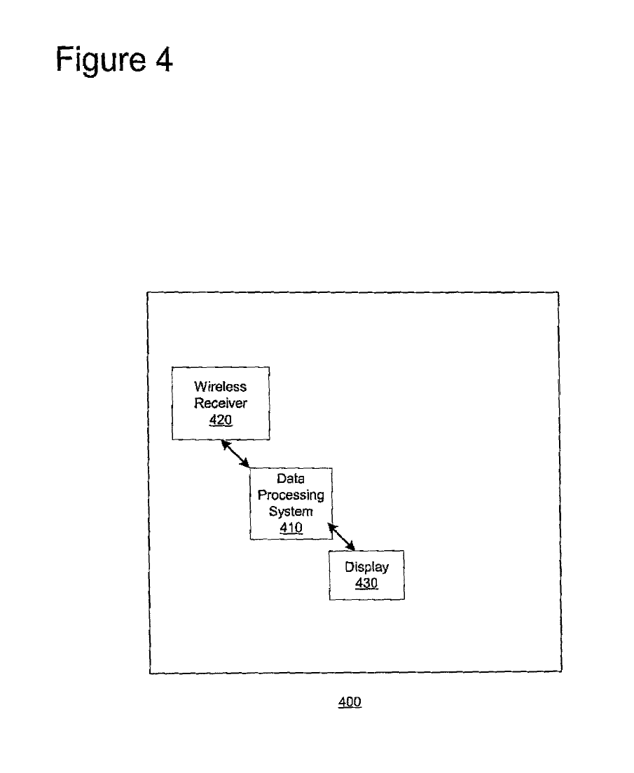

FIG. 4 is an exemplary diagram of a preferred embodiment of a time synchronization device, such as would be coupled to time devices 106-114 in FIG. 1, according to a preferred embodiment of the present invention. The time synchronization device comprises a data processing system 410, a wireless receiver 420 and display 430. The wireless receiver 420 is coupled to the data processing system 410 such that data may be received by the data processing system 410 and the wireless receiver 420 and data may be sent to the wireless receiver 420 from the data processing system 410.

Time synchronization device 400 may be any type of data processing system 410 that is capable of receiving time synchronization data. The data processing system 400 may be any type of data processing system that is capable of receiving time synchronization data and performing processing on the time synchronization data. The data processing system 410 may be the data processing system depicted in FIG. 3, for example. In addition, time synchronization device 400 may be any time piece having sufficient processing capability to perform the time synchronization described herein.

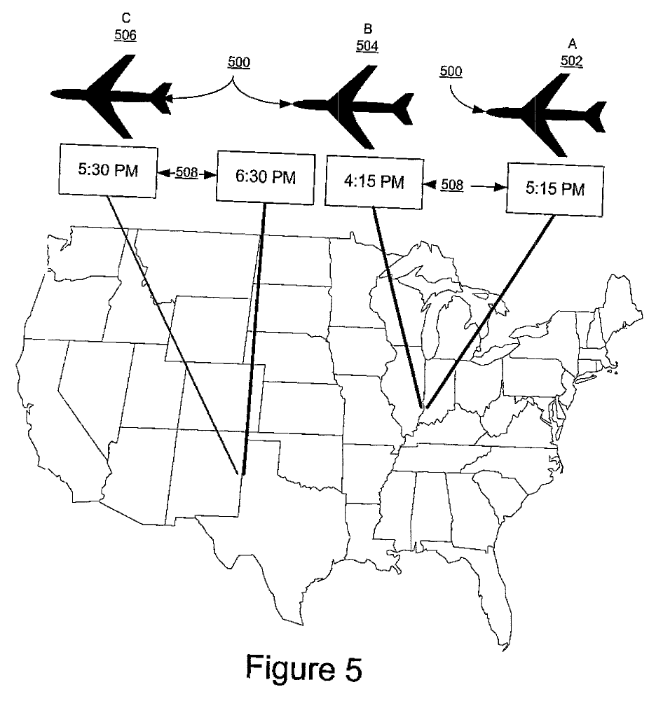

FIG. 5 is an exemplary illustration of adjusting the time for a device crossing time zone boundaries in accordance with a preferred embodiment of the present invention. As discussed above, the present invention automatically adjusts the time for a device with a clock or time piece when traveling from location to location. The present invention is especially valuable when traveling from one time zone to another time zone. In such a case, the present invention will sense the location of the device, by using, for example, a global positioning (GPS) signal to establish that a time zone boundary has been reached. When the time zone boundary is crossed, the time on the clock or time piece will be adjusted in either a forward or backward direction to correspond to the correct current local time.

In this example, at location A 502, vehicle 500 is about to reach a time zone boundary between the Eastern and Central time zone of the United States. Clock or time piece 508 at location A 502 indicates that it is 5:15 PM. However, as soon as vehicle 500 crosses the time zone boundary between the Eastern time zone and the Central time zone, and is at location B 504, clock or time piece 508 is automatically adjusted back one hour to indicate that the local time at location B 504 is exactly one hour behind the local time, or 4:15 PM, at location A 502. Furthermore, at location B 504, vehicle 500 is about to reach a time zone boundary between the Central time zone and Mountain time zone of the United States. Clock or time piece 508 at location B 504 indicates that it is 6:30 PM. However, as soon as vehicle 500 crosses the time zone boundary between the Central time zone boundary and the Mountain time zone boundary, and is at location C 506, clock or time piece 508 is automatically adjusted back one further hour to indicate that the local time at location C 506 is exactly one hour behind the local time, or 5:30 PM, at location B 504.

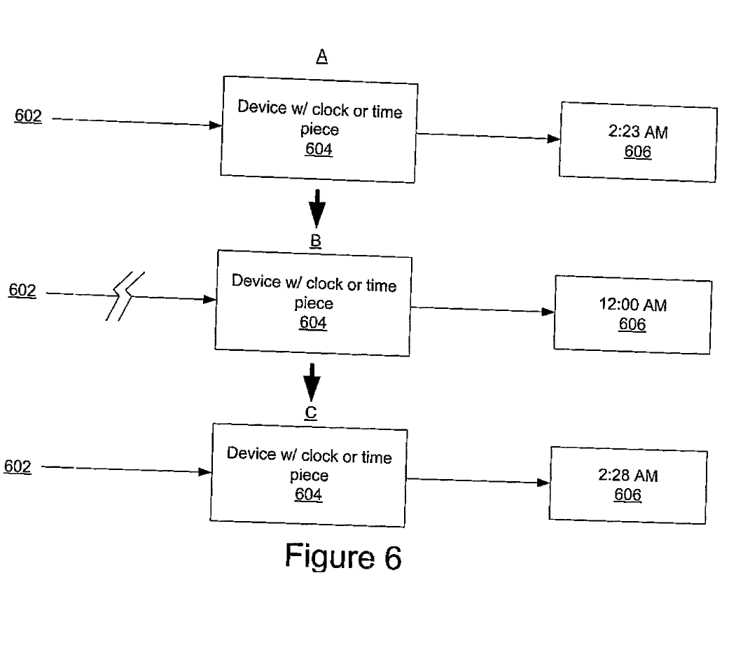

FIG. 6 is an exemplary illustration of adjusting the time for a device after an interruption in power to the device in accordance with a preferred embodiment of the present invention. Often, and at the most inconvenient times, power to a device is initialized or interrupted thereby resulting in the wrong time being displayed on a clock or time piece associated with the device. Many times, especially during the night when most people are sleeping, an instantaneous or short suspension in the power supply to the device is not noticed. However, many devices which also include a clock or time piece, in response to the power initialization or interruption, will either register the wrong time or revert to a benchmark time in which, after power to the device is restored, time will be displayed starting at this benchmark time.

Therefore, if power initialization or interruption to the device does occur, then the wrong time will be displayed upon the clock or time piece. In such a case, the present invention senses that power to the device has been initialized or interrupted and in turn will sense that power to the device has been established. When power is reestablished to the device containing the clock or time piece, the location of the device will again be established and the correct current local time will be input and displayed on the clock or time piece associated with the device.

In this example, in scenario A, power signal 602 is input into device 604 which contains a clock or time piece. The display on the clock or time piece 606 in scenario A is 2:23 AM. However, in scenario B, power signal 602 has been interrupted to device 604 which contains a clock or time piece. The interruption of the power to device 604 in scenario B has caused the display on clock or time piece 606 to revert to a benchmark time of 12:00 AM. In this example, assume that power is off to device 604 for a period of 5 minutes. When power signal 602 is restored to device 604, the clock or time piece 606 will automatically be reestablished, based on the location of device 606, to 2:28 AM which accounts for the five minutes that power signal 602 was interrupted into device 604. The correct time is shown on clock or time piece 606 and thereby the device may be counted on to provide the current local time no matter how long or when power has been interrupted from device 604.

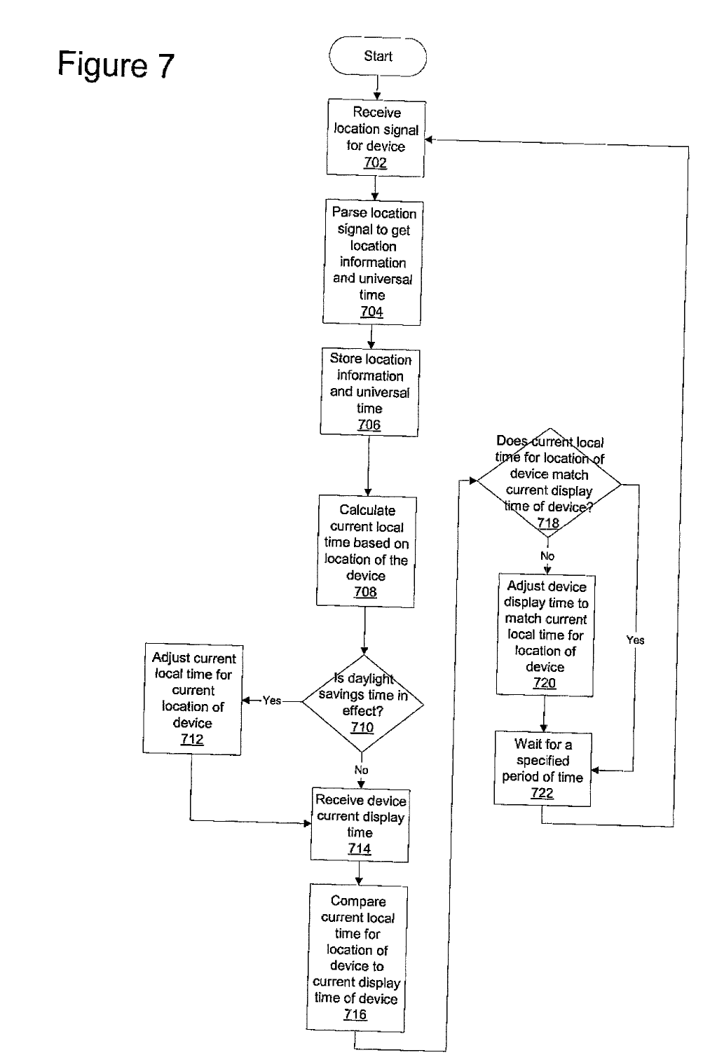

FIG. 7 is an exemplary flow chart illustrating verification of time on a clock or time piece in accordance with a preferred embodiment of the present invention. In this example, the operation starts by receiving a location signal for a device (step 702). The location signal is parsed to gather location information and universal time (step 704). The location information and universal time are stored (step 706). This location information and universal time are stored for later processing. Current local time is calculated based on the location of the device (step 708). A determination is then made as to whether or not daylight savings time is in effect (step 710). If daylight saving time is in effect (step 710:YES), current local time is adjusted accordingly for the current location of the device (step 712). The operation then continues to step 714 in which device current display time is received.

If daylight savings time is not in effect (step 710:NO), then device current display time is received (step 714). The current local time for the location of the device is compared to the current display time of the device (step 716). A determination is then made as to whether or not the current local time for the location of the device matches the current display time for the device (step 718). A device may be adapted to receive a user modified time such that the comparison is made, not of the display time, but of the user modified time. For example, this may enable a user to set a clock ahead or backwards, for example, five minutes. If the current local time for the location of the device does match the current display time for the device (the current local time is meant to indicate an actual current local time or the user modified time) (step 718:YES), the operation continues to step 722 in which a specified period of time is awaited. If the current local time for the location of the device does not match the current display time of the device (step 718:NO), the device display time is adjusted to match the current local time for the location of the device (step 720). Then a specified period of time is awaited (step 722). A specified period of time is awaited so that the operation is not in a tight loop and locks out any and all other processes in, for example, a data processing system. In addition, this specified period of time is awaited so that a power source, for example, a battery in the device is not constantly running. The operation then returns to step 702 in which a location signal for the device is received.

Therefore, the present invention provides a method and apparatus for automatically synchronizing electronic clocks and time pieces to the correct local time irrespective of where the clock or time piece is located in the world. By using an accurate signal source containing current location information and a timestamp, the present invention provides a mechanism with accurate local current time based on the position of the device. The present invention allows for automatically determining the location of the device and the local time associated with this location. The present invention may periodically sample a signal and receive the timestamp from the signal and calculate an accurate local time and additionally periodically validate this local time. If there happens to be a discrepancy in the time shown by the clock or time piece associated with the device, the device's clock or time piece is automatically corrected. Therefore, the user of the clock or time piece will never have to be concerned about manually resetting a clock or time piece or worry about the accuracy of the time shown on the clock or time piece.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communication links, wired or wireless communication links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for determining time synchronization of a a timing device, the method comprising the steps of:
obtaining geographic position data from a device associated with the timing device;
calculating a current local time for a location of the device associated with the timing device based on the geographic position data; and
synchronizing the timing device with the current local time.

2. The method as recited in claim 1, wherein the timing device includes at least one of a clock and a time piece associated with the device.

3. The method as recited in claim 1, wherein synchronizing the timing device with the current local time includes at least one of adjusting time on the timing device to correspond to the current local time for the location of the device and verifying time on the timing device corresponding to the current local time for the location of the device.

4. The method as recited in claim 1, further comprising:
comparing the calculated current local time for the location of the device associated with the geographic position data with time on the timing device; and
responsive to a difference between the calculated current local time and the time on the timing device, adjusting the time on the timing device to match the calculated current local time for the location of the device.

5. The method as recited in claim 1, further comprising:
determining whether a time adjustment has occurred; and
in response to the occurrence of the time adjustment, adjusting the time on the timing device to match the time adjustment.

6. The method as recited in claim 5, wherein the time adjustment is a change in time zones.

7. The method as recited in claim 6, wherein the time adjustment is a change in daylight savings time.

8. The method as recited in claim 7, further comprising:
responsive to the start of daylight savings time, adjusting the time on the timing device accordingly for the location of the device associated with the geographic position data.

9. The method as recited in claim 7, further comprising:
responsive to the end of daylight savings time, adjusting the time on the timing device accordingly for the location of the device associated with the geographic position data.

10. The method as recited in claim 1, wherein obtaining geographic position data from the device includes obtaining geographic position data from a Global Positioning System (GPS).

11. The method as recited in claim 1, wherein the current local time includes an actual current Local time and a user modified time.

12. The method as recited in claim 11, wherein the user modified time differs from the actual current local time.

13. A method for receiving time synchronization of a timing device, the method comprising the steps of:
transmitting geographic position data from a device associated with the timing device;
transmitting time on the timing device;
receiving the current local time for a location of the device associated with the timing device based on the geographic position data; and
adjusting the time on the timing device to match the current local time for the location of the device associated with the geographic position data.

14. An apparatus, comprising:
a bus system;
a communications unit functionally connected to the bus system;
a storage unit functionally connected to the bus system;
a time synchronization unit functionally connected to the bus system; and
a processing unit functionally connected to the bus system, wherein the processing unit instructs the communications unit to obtain geographic position data from a device associated with a timing device, the processing unit calculates a current local time for a location of the device associated with the timing device based on the geographic position data, and the processing unit instructs the time synchronization unit to synchronize the timing device with the current local time.

15. An apparatus, comprising:
a bus system;
a communications unit functionally connected to the bus system;
a time synchronization unit functionally connected to the bus system; and
a processing unit functionally connected to the bus system, wherein the processing unit instructs the communications unit to transmit geographic position data from a device associated with the timing device, the processing unit instructs the communication unit to transmit time on the timing device, the processing unit receives, via the communications unit, current local time for a location of the device associated with the timing device based on the geographic position data, and the processing unit instructs the time synchronization unit to adjust the time on the timing device to match the current local time for the location of the device associated with the geographic position data.

16. A system for determining time synchronization of a a timing device, comprising:
obtaining means for obtaining geographic position data from a device associated with the timing device;
calculating means for calculating a current local time for a location of the device associated with the timing device based on the geographic position data; and
synchronizing means for synchronizing the timing device with the current local time.

17. The system as recited in claim 16, further comprising:
comparing means for comparing the current local time for the location of the device associated with the geographic position data with time on the timing device; and
adjusting means, responsive to a difference between the current local time and the time on the timing device, for adjusting the time on the timing device to match the current local time for the location of the device.

18. The system as recited in claim 16, further comprising:
determining means for determining whether a time adjustment has occurred; and
adjusting means, in response to the occurrence of the time adjustment, for adjusting the time on the timing device to match the time adjustment.

19. A system for receiving time synchronization of a timing device, the method comprising the steps of:
transmitting means for transmitting geographic position data from a device associated with the timing device;
transmitting means for transmitting time on the timing device;
receiving means for receiving current local time for a location of the device associated with the timing device based on the geographic position data,; and
adjusting means for adjusting the time on the timing device to match the current local time for the location of the device associated with the geographic position data.

20. A computer program product in a computer-readable medium for determining time synchronization of a a timing device, comprising:
instructions for obtaining geographic position data from a device associated with the timing device;
instructions for calculating a current local time for a location of the device associated with the timing device based on the geographic position data; and
instructions for synchronizing the timing device with the current local time.

21. The computer program product as recited in claim 20, further comprising:
instructions for comparing the current local time for the location of the device associated with the geographic position data with time on the timing device; and
instructions, responsive to a difference between the current local time and the time on the timing device, for adjusting the time on the timing device to match the current local time for the location of the device.

22. The computer program product as recited in claim 20, further comprising:
instructions for determining whether a time adjustment has occurred; and
instructions, in response to the occurrence of the time adjustment, for adjusting the time on the timing device to match the time adjustment.

23. A computer program product in a computer-readable medium for receiving time synchronization of a timing device, comprising:
instructions for transmitting geographic position data from a device associated with the timing device;
instructions for transmitting time on the timing device;
instructions for receiving current local time for a location of the device associated with the timing device based on the geographic position data,; and
instructions for adjusting the time on the timing device to match the current local time for the location of the device associated with the geographic position data.
